(19) United States
(12) Patent Application Publication
(10) Pub. No.: US 2006/0045988 A1
(43) Pub. Date: Mar. 2, 2006

(54) Pretreatment process of a substrate in micro/nano imprinting technology

(75) Inventors: Yoou-Bin Guo, Kaohsiunghsien (TW); Chiao-Yang Cheng, Hsinchu City (TW); Chau-Nan Hong, Tainan City (TW); Min-Hsiung Hon, Tainan City (TW)

Correspondence Address: SUGHRUE MION, PLLC, 2100 PENNSYLVANIA AVENUE, N.W., SUITE 800, WASHINGTON, DC, 20037, US

(73) Assignee: NATIONAL CHENG KUNG UNIVERSITY

(21) Appl. No.: 11/211,717

(22) Filed: Aug. 26, 2005

(30) Foreign Application Priority Data
Aug. 27, 2004 (TW) 93125913

(51) Int. Cl. H05H 1/24

(52) U.S. Cl. 427/569

(57) ABSTRACT

A pretreatment process of a substrate in a micro/nano imprinting technology is disclosed, comprising deposing the substrate on a holder and performing a plasma treatment or an ion treatment on the substrate. In the plasma treatment of the substrate, a reactive gas is first injected into the chamber to form a plasma, such that the plasma causes a physical reaction and a chemical reaction on the substrate to activate the substrate surface and also remove particles and contaminants adhering to the substrate surface. When the ion treatment is performed on the substrate, an ion source is placed into the chamber and ions and neutral atoms generated by the ion source bombard the substrate, causing a physical reaction and a chemical reaction on the substrate to activate the substrate surface and also remove particles and contaminants adhering to the substrate surface.

### RELATED APPLICATIONS

The present application is based on, and claims priority from, Taiwan Application Serial Number 93125913, filed Aug. 27, 2004, the disclosure of which is hereby incorporated by reference herein in its entirety.

### FIELD OF THE INVENTION

The present invention relates to a pretreatment process of a substrate in a micro/nano imprinting technology, and more particularly, to a process for using plasma to treat a surface of a substrate prior to a micro/nano imprinting process.

### BACKGROUND OF THE INVENTION

Optical lithography plays a very important role in semiconductor processing. As electronic devices are continuously miniaturized, the exposure light wavelength for lithography is gradually decreased. With limitations of light and the requirement for high-energy radiation, the processing apparatuses and techniques in the photolithography process for achieving nanoscale patterns are more complicated and more precise than those used in microscale processes, thereby causing high apparatus cost and high technique risk among others. In the current semiconductor techniques, the expensive mask and apparatus in the photolithography and etching processes have become barriers for semiconductors to reach the scale of 50 nanometers.

The nanoimprinting lithography technique is a new nanoscale processing technique, which can be used to manufacture a pattern with dimensions smaller than 10 nm. In the printing technique, only one printing mold is manufactured, and then the printing mold can be repeatedly and rapidly used to print or transfer the patterns, which is very convenient and easy. In addition, the printing technique can also be applied in the fabrication of a large-scale pattern, so that the production cost can be greatly decreased. Therefore, this printing technique has been widely applied in pattern formation and device fabrication.

In the printing and the pattern-transfer techniques, the microcontact printing technique and the micro/nano imprinting technique have wider applications, of which both are not the traditional exposure and development processing techniques and have the advantages of low cost and high productivity.

In the current practice, when a device is fabricated on a substrate, an ultrasonic cleaning step is firstly performed on the substrate by using an ethanol or acetone solution, so as to remove grease contamination and particles adhered to the substrate surface. The ultrasonic cleaning step is time-consuming, leaves residue from the evaporation of the solvent, and is limited in its ability to remove surface contaminants. Furthermore, the ultrasonic cleaning step cannot chemically modify the substrate surface to enhance the adhesion of the resist to the substrate.

### SUMMARY OF THE INVENTION

Therefore, one objective of the present invention is to provide a pretreatment process of a substrate in a micro/nano imprinting technology, which cleans the substrate surface by using plasma or ions prior to a micro/nano imprinting step, so that impurities, particles and grease contamination adhered to the substrate surface can be removed by the physical bombardment of ions in the plasma, thereby greatly improving the bonding ability of substrate and increasing the adhesion between the coating of etching resist and the substrate.

Another objective of the present invention is to provide a pretreatment process of a substrate in a micro/nano imprinting technology, which modifies the surface structure of a substrate prior to a micro/nano imprinting step by using a chemical method, such as reactions of ions or reactive species in the plasma, so that the substrate surface are modified with particular chemical functional groups. Accordingly, the adhesion between a resist and the substrate can be increased, thereby greatly enhancing the yield of the imprinting process.

According to the aforementioned objectives, the present invention provides a pretreatment process of a substrate in a micro/nano imprinting technology comprising depositing a substrate in a chamber and performing a plasma treatment or an ion treatment on the substrate, in which the plasma treatment or the ion treatment comprises injecting a reactive gas into the chamber and forming a plasma or an ion source by using the reactive gas, such that the plasma or ions cause a physical reaction and a chemical reaction on the substrate.

According to a preferred embodiment of the present invention, a reactive pressure of the plasma treatment is between about 10⁻⁶ torr and about 1500 torr, the substrate is deposed on a plasma electrode of the chamber, and a frequency of a power applied to the plasma electrode is between direct current frequency and above microwave frequency (˜GHz). Furthermore, the reactive gas preferably comprises an inert gas and an active gas, in which the inert gas can be Ar, He, Ne or any combination thereof, and the active gas can be O₂, N₂, water vapor, gas molecules containing C, H, O F or Si elements, or any combination thereof.

By using plasma or ions to treat the imprinting substrate surface prior to the micro/nano imprinting process, the cleanness of the imprinting substrate surface can be greatly increased, and the substrate surface can be activated by the plasma to form functional groups on the substrate surface so that adhesion between the imprinting substrate and a resist can be enhanced. Therefore, bubbles resulting from poor adhesion of the resist during coating can be decreased and the objective of significantly increasing the yield of the micro/nano imprinting process can be achieved.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1 to 4 are schematic flow diagrams showing a micro/nano imprinting process in accordance with a preferred embodiment of the present invention.

### DETAILED DESCRIPTION OF THE PREFERRED EMBODIMENT

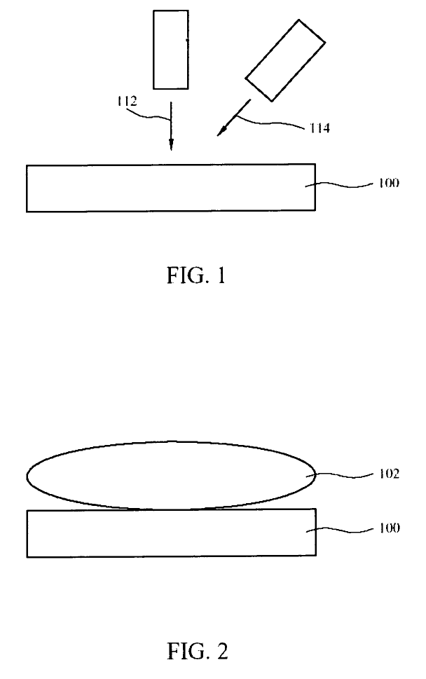

The present invention discloses a pretreatment process of a substrate in a micro/nano imprinting technology, which uses plasma or ions to clean and modify the surface characteristics of a substrate surface prior to a micro/nano imprinting process, so that grease and solid particle contaminants adhered to the substrate surface can be removed. Therefore, the planarization and uniformity of the substrate and resist coated thereon can be enhanced, the adhesion between the resist and the substrate can be increased, and the objectives of greatly enhancing the yield of the imprinting process and accuracy of the nanopattern can be achieved. In order to make the illustration of the present invention more explicit and complete, the following description is stated with reference to FIGS. 1 to 4.

A micro/nano imprinting process is generally referred to as a print process for transferring patterns of micro/nano scale, which includes a hot embossing technique, a microcontact printing technique and a step-and-flash imprinting lithography technique. The micro/nano imprinting imaging technique principally includes the fabrication of a printing mold in the front end and a micro/nano scale shaping technique in the back end. The printing mold is firstly fabricated by using e-beam lithography or photolithography to project an image on the resist followed by an etching step to form the micro/nano patterns on the printing mold. Then, the imprinting shaping procedure of the micro/nano patterns is performed by directly imprinting the micro/nano printing mold onto a resist coated on the substrate, so that the micro/nano patterns are obtained.

FIGS. 1 to 4 are schematic flow diagrams showing a micro/nano imprinting process in accordance with a preferred embodiment of the present invention. The micro/nano imprinting technology may be a hot-embossing, a UV-curing imprinting or a step-and-flash imprinting. Firstly, a substrate 100 is provided, which may be a hard substrate, such as made of glass, silicon, metal or ceramic, a soft flexible substrate, such as made of plastics, rubber, elemental metallic or alloyed metallic sheet or foil, or a composite substrate composed of the aforementioned materials with a special surface treatment, such as plating a transparent conductive material. In the present invention, composite substrate may be a hard or flexible substrate doped with fine structure material or coated with a ceramic material. A material of the metal sheet or foil comprising the substrate 100 is, for example, copper or nickel, and a material of the alloy sheet or foil is, for example, a steel.

Next, the substrate 100 is rinsed by a liquid stream 112 and brushed by a high-speed airstream 114, so as to remove large contaminants adhered to the surface of the substrate 100 to clean the substrate 100 in advance, as illustrated in FIG. 1. The step of rinsing the substrate 100 comprises using a rinsing liquid, which may include pure water, water solution containing chemical materials, organic solvents or any combination thereof. For a substrate protected by a thin film originally, the rinsing step can be omitted.

Then, referring to FIG. 2, the substrate 100 is deposed on a holder (not shown). In one embodiment, the substrate 100 is transferred into a chamber (not shown) of a plasma treatment device or an ion treatment device, and a plasma treatment or an ion treatment is performed on the substrate 100, in which the chamber is either a system with pressure lower than one atmosphere or a system with pressure around or above one atmosphere. In the low pressure (vacuum or lower than one atmosphere) plasma treatment device, the chamber comprises a plasma electrode, and the substrate 100 is preferably deposed on the plasma electrode in the chamber. In the high pressure system with pressure around or above one atmosphere, the plasma can also be generated to treat the substrate 100 by using atmospheric pressure discharges, such as dielectric barrier discharge (DBD), cold plasma jets, thermal plasma torches, corona discharges, etc., under open environment. Subsequently, a reactive gas for forming plasma 102 on the substrate 100, such as an inert gas comprising Ar, He and Ne, is injected into the chamber to perform physical bombardment on the substrate 100 by the plasma. The reactive gas can also be that which can cause a plasma chemical reaction on the substrate 100, such as an active gas comprising O₂, N₂, water vapor, or gas molecules containing C, H, O, F or Si elements. Furthermore, the reactive gas can be a mixture in a predetermined ratio of the aforementioned inert gases and active gases according to the processing requirement. After the reactive gas is injected into the chamber, power is supplied to the plasma electrode, so as to produce the plasma 102 on or above the surface of the substrate 100. In the plasma treatment of the substrate 100, the plasma treatment device can be operated anywhere between 10⁻⁶ torr to 1500 torr, so that plasma species can bombard or react with the substrate surface. The range of the power frequency used to produce the plasma 102 for extracting ions is between direct current frequency and microwave frequency (˜GHz), including radio frequency (RF, ˜MHz). In the present invention, the structure and related elements, such as the category and the magnitude of the electric field, of the plasma electrode are not limited as long as the plasma 102 is produced with electrons, ions or reactive species (e.g. free radicals) arriving on/to the substrate 100.

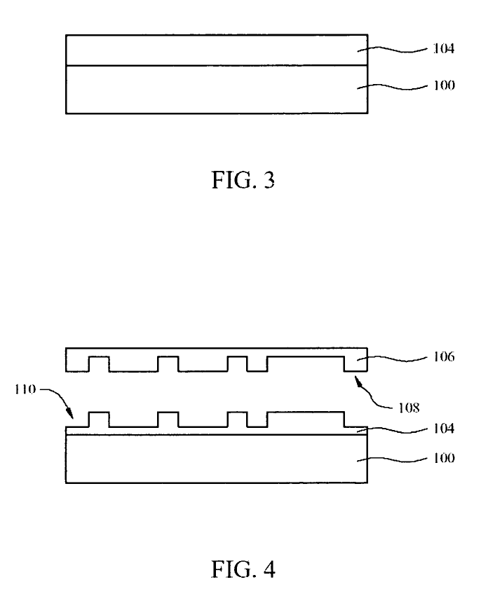

A physical reaction, such as a physical ion bombardment, and a chemical reaction, such as a chemical bonding reaction, are performed on the surface of the substrate 100 by the active species including ions and free radicals in the plasma 102 formed on the substrate 100 or a predetermined distance away from the substrate (remote plasma). In the present invention, the chemical reaction induces new functional groups and structure on the surface of substrate 100. In another embodiment, the plasma treatment of the substrate comprises applying a power to a plasma electrode generating the plasma, and the substrate is deposed a predetermined distance away from the plasma electrode, wherein the substrate is not directly exposed to the plasma. In still another embodiment, the plasma treatment of the substrate comprises applying a power to a plasma electrode generating the plasma, and the substrate is deposed on another electrode which is simultaneously powered by another power supply. The solid microscopic particles and physically adhered molecules on the surface of the substrate 100 are removed by the physical reaction performed on the substrate 100 with the plasma 102, which greatly enhances the cleanness and modifies the morphology of the substrate 100 surface to increase its adhesive strength with a resist 104 (referring to FIG. 3) coated subsequently. In the chemical reaction performed on the substrate 100 by the plasma 102, the plasma 102 reacts with the chemicals adhered on the surface of the substrate 100 to form small gaseous molecules that depart from the surface of the substrate 100, thus modifying the surface structure of the substrate 100. In the modification of the surface structure of the substrate 100 by the plasma 102, the broken bonds on the exposed surface of the substrate 100 are connected with specific chemical functional groups, including powerful chemical bonds, such as —CO—, —CN— or —C—Si—, and a plurality of active sites are formed on the surface of the substrate 100, which can remove grease contaminants on the surface of the substrate 100, enhance the coating uniformity of the resist 104 on the substrate 100, and enhance the adhesion between the resist 104 and the substrate 100. Therefore, the yield of the imprinting process can be significantly enhanced after this pretreatment, especially in nanoscale imprinting processes, since the surface morphologies and adhesiveness of the substrate 100 is critical to pattern transfer success.

In another embodiment of the present invention, the substrate 100 is treated by using ions. When the ion treatment is performed on the substrate 100, an ion source, such as an ion-gun, is deposed into the chamber; and a reactive gas for forming ions is injected into the chamber. The ion source produces ions or neutral atoms from the reactive gas to strike the substrate 100. The reactive gas and the gas ratio used for producing the ion source can be the same as that used for producing the plasma 102 in the aforementioned embodiment. The ions and the neutral atoms produced by the ion source cause a physical reaction and a chemical reaction with the substrate 100, which remove particles and contaminants adhered to the surface of the substrate 100 and activate the surface of the substrate 100.

Referring to FIG. 3, after the plasma treatment or the ion treatment of the substrate 100 is completed, a resist 104 is formed to cover the substrate 100 by, for example, a spin coating method. Due to the surface of the substrate 100 being cleaned and modified by the plasma 102 or the ions, the resist 104 can be uniformly formed on the surface of the substrate 100, and the adhesion of the resist 104 to the surface of the substrate 100 can be effectively increased.

Then, a mold 106 for imprinting is provided, in which a surface of the mold 106 includes a pattern 108. Next, a heating step is performed to increase the processing temperature to be greater than a glass transition temperature of the resist 104. The imprinting mold 106 is pressed onto the resist 104 to transfer the pattern 108 of the surface of the mold 106 to the resist 104. Subsequently, the processing temperature is reduced, and the mold 106 is removed from the resist 104 so that a pattern 1 10, which is complementary to the pattern 108 in the surface of the mold 106, is obtained in the resist 104 on the substrate 100, as shown in FIG. 4.

According to the aforementioned description, one advantage of the present invention is that the present invention uses plasma or ions to treat a surface of an imprinted substrate prior to a micro/nano imprinting process. By physical reactions and chemical reactions caused on the surface of the substrate by the active species including the ions and free radicals, the particles, grease contamination and physically adhered molecules can be effectively removed, and the coating uniformity of the resist can be greatly enhanced.

According to the aforementioned description, another advantage of the present invention is that the present invention uses plasma or ions to cause a chemical reaction, such as a chemical bonding reaction, on a surface of the substrate to modify the surface of the substrate prior to a micro/nano imprinting process, so as to produce active sites and chemical functional groups on the surface of the substrate. Accordingly, the adhesion between the resist and the substrate is increased, and the yield of the imprinting process and the precision of the nanopatterns can be significantly enhanced.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A pretreatment process of a substrate in a micro/nano imprinting technology, comprising:
deposing the substrate on a holder; and
performing a plasma treatment on the substrate, comprising:
infusing a reactive gas; and
applying a power to form a plasma by using the reactive gas to cause a physical reaction and a chemical reaction with the substrate.

2. The pretreatment process of a substrate in a micro/nano imprinting technology according to claim 1, wherein the micro/nano imprinting technology is a hot-embossing, a UV-curing imprinting or a step-and-flash imprinting.

3. The pretreatment process of a substrate in a micro/nano imprinting technology according to claim 1, wherein the substrate is a hard substrate or a soft flexible substrate.

4. The pretreatment process of a substrate in a micro/nano imprinting technology according to claim 1, wherein a material of the substrate is selected from the group consisting of glass, silicon, metal, ceramic, plastics and rubber.

5. The pretreatment process of a substrate in a micro/nano imprinting technology according to claim 1, wherein a material of the substrate is selected from the group consisting of a metal sheet or foil composed of a single metallic element and an alloy sheet or foil composed of a plurality of metallic elements, wherein a material of the metal sheet or foil is selected from the group consisting of Cu and Ni, and a material of the alloy sheet or foil comprises a steel.

6. The pretreatment process of a substrate in a micro/nano imprinting technology according to claim 1, wherein the substrate is selected from the group consisting of glass, silicon, metal, ceramic, plastic and rubber, each of which has a surface plated with a transparent conductive ceramic material.

7. The pretreatment process of a substrate in a micro/nano imprinting technology according to claim 1, wherein a reactive pressure of the plasma treatment is between 10⁻⁶ torr and 1500 torr.

8. The pretreatment process of a substrate in a micro/nano imprinting technology according to claim 1, wherein a chamber is employed and the chamber comprises a plasma electrode, the plasma treatment comprises applying the power to the plasma electrode, and the substrate is deposed on the plasma electrode.

9. The pretreatment process of a substrate in a micro/nano imprinting technology according to claim 1, wherein the plasma treatment comprises applying the power to a plasma electrode generating the plasma, and the substrate is deposed at a predetermined distance away from the plasma electrode, wherein the substrate is not directly exposed to the plasma.

10. The pretreatment process of a substrate in a micro/nano imprinting technology according to claim 1, wherein the plasma treatment comprises applying the power to a plasma electrode generating the plasma, and the substrate is deposed on another electrode which is simultaneously powered by another power supply.

11. The pretreatment process of a substrate in a micro/nano imprinting technology according to claim 1, wherein a plasma treatment is performed on the substrate without using any chamber, and the plasma produced by atmospheric discharge or plasma torch at around or above the pressure of one atmosphere treats the substrate under open environment.

12. The pretreatment process of a substrate in a micro/nano imprinting technology according to claim 1, wherein the plasma is produced by applying the power to a plasma electrode generating the plasma, and the frequency of the power is between direct current frequency and microwave frequency (˜GHz), including radio frequency (RF, ˜MHz).

13. The pretreatment process of a substrate in a micro/nano imprinting technology according to claim 1, wherein the reactive gas comprises an inert gas, and the inert gas is selected from the group consisting of Ar, He, Ne and any combination thereof, wherein the physical reaction is an ion bombardment reaction.

14. The pretreatment process of a substrate in a micro/nano imprinting technology according to claim 1, wherein the reactive gas comprises an active gas, and the active gas is selected from the group consisting of O₂, N₂, water vapor, gas molecules containing C, H, O, F or Si elements and any combination thereof, wherein the chemical reaction is a chemical bonding reaction.

15. The pretreatment process of a substrate in a micro/nano imprinting technology according to claim 1, wherein the reactive gas comprises a mixture gas combined inert gases and active gases, and the inert gas is selected from the group consisting of Ar, He, Ne and any combination thereof; the active gas is selected from the group consisting of O₂, N₂, water vapor, gas molecules containing C, H, O, F or Si elements and any combination thereof.

16. The pretreatment process of a substrate in a micro/nano imprinting technology according to claim 1, prior to the step of deposing the substrate within the chamber, further comprising performing a liquid rinsing step and a high-speed airstream brushing step to pre-treat and clean the substrate, wherein the liquid rinsing step comprises using a rinsing liquid, and the rinsing liquid is selected from the group consisting of pure water, water solution containing chemical materials, organic solvent and any combination thereof.

17. A pretreatment process of a substrate in a micro/nano imprinting technology, comprising:
deposing the substrate within a chamber; and
performing an ion treatment on the substrate, comprising:
infusing a reactive gas into the chamber; and
forming ion species by using the reactive gas to cause a physical reaction and a chemical reaction with the substrate.

18. The pretreatment process of a substrate in a micro/nano imprinting technology according to claim 17, wherein the micro/nano imprinting technology is a hot-embossing, a UV-curing imprinting or a step-and-flash imprinting.

19. The pretreatment process of a substrate in a micro/nano imprinting technology according to claim 17, wherein the substrate is a hard substrate, a soft flexible substrate or a composite substrate, wherein a material of the hard substrate is selected from the group consisting of glass, silicon, metal and ceramic, and a material of the flexible substrate is selected from the group consisting of plastics, rubber, metal sheet or foil and any combination thereof, and a material of the composite substrate is a hard or flexible substrate doped with fine structure material or coated plated with a ceramic material.

20. The pretreatment process of a substrate in a micro/nano imprinting technology according to claim 17, wherein a frequency of the power to produce the plasma for extracting ions is between direct current frequency and microwave frequency (˜GHz), including radio frequency (RF, ˜MHz).

21. The pretreatment process of a substrate in a micro/nano imprinting technology according to claim 17, wherein the reactive gas comprises an inert gas, active gas and any combination thereof, wherein
the inert gas is selected from the group consisting of Ar, He, Ne and any combination thereof, and the physical reaction is an ion bombardment reaction; and
the active gas is selected from the group consisting of O₂, N₂, water vapor, gas molecules containing C, H, O, F or Si elements and any combination thereof, and the chemical reaction induces new functional groups and structure on the surface of substrate.

22. The pretreatment process of a substrate in a micro/nano imprinting technology according to claim 17, prior to the step of deposing the substrate within the chamber, further comprising performing a liquid rinsing step and a high-speed airstream brushing step to pre-treat and clean the substrate, wherein the liquid rinsing step comprises using a rinsing liquid, and the rinsing liquid is selected from the group consisting of pure water, water solution containing chemical materials, organic solvent and any combination thereof.
